(19) United States
(12) Patent Application Publication
(10) Pub. No.: US 2008/0062242 A1
(43) Pub. Date: Mar. 13, 2008

(54) Optical print head with non-Gaussian irradiance

(75) Inventors: Andrew L. Van Brocklin, Corvallis, OR (US); Kuohua Wu, Corvallis, OR (US); Vladek P. Kasperchik, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Fort Collins, CO (US)

(21) Appl. No.: 11/520,514

(22) Filed: Sep. 12, 2006

(51) Int. Cl. B41J 2/455

(52) U.S. Cl. 347/233

(57) ABSTRACT

An optical print head includes a plurality of lasers having laser emissions within a desired wavelength range, a beam splitter and/or a multi-mode optical fiber adapted to receive combined output light from the plurality of lasers and to direct their combined output light in a first beam direction. A holographic or hybrid holographic optical element is adapted to focus the combined output light within the desired wavelength range into a spot with non-Gaussian irradiance on the medium for recording. A sensor may be disposed along a second beam direction to detect modulated light from the medium.

### CROSS-REFERENCE TO RELATED APPLICATION

This application is related to co-pending and commonly assigned application Ser. No. ______, filed on the same date herewith (attorney docket no.200600004-1), the entire disclosure of which is incorporated herein by reference.

### TECHNICAL FIELD

This invention relates generally to optical recording and more particularly to optical print heads.

### BACKGROUND

Optical recording technology that enables consumers and others to record laser-written labels on specially coated recordable CD and DVD media has enjoyed notable commercial success. In light-activated thermal label-recording technology, a surface of the medium is coated with a writable layer of a material that changes appearance when it absorbs laser light of a predetermined wavelength. The color change interaction in a thermochromic imageable coating is enabled by phase transitions of the coating materials happening at elevated temperatures. These phase transitions do not happen (and, so color doesn't develop) until the coating temperature reaches a certain value specific to the coating material. If the coating is irradiated with laser energy density that is not high enough to reach the phase transition, the color is not developed. Thus, if a writable layer is exposed to laser radiation with an irradiance distribution in which significant portions have insufficient irradiance to reach the color-forming (phase transition) temperature, some of the energy of the laser radiation is wasted. When relatively high-power laser radiation is required, cost increases can occur due to disproportionately higher laser cost. When multiple laser wavelengths are required, such as for color recording, differences in focal distance for the various laser wavelengths may require optics compatible with a focusing servo system. Thus, there is a need for further improvement in marking of media.

### BRIEF DESCRIPTION OF THE DRAWINGS

The features and advantages of the disclosure will readily be appreciated by persons skilled in the art from the following detailed description when read in conjunction with the drawings, wherein:

FIGS. 1A and 1B are graphs depicting irradiance distributions of laser light.

FIG. 2 is a schematic optical diagram of a first embodiment of an optical print head.

FIG. 3 is a schematic optical diagram of a portion of a second embodiment of an optical print head.

FIG. 4 is a schematic optical diagram of apparatus for making an embodiment of a holographic optical element for an optical print head.

FIG. 5 is a schematic optical diagram of a portion of a third embodiment of an optical print head.

FIG. 6 is a perspective view of a three-dimensional graph depicting an exemplary embodiment of an irradiance distribution of laser light.

FIG. 7 is a schematic optical diagram of a fourth embodiment of an optical print head.

FIG. 8 is a schematic optical diagram of a portion of a fifth embodiment of an optical print head.

FIG. 9 is a schematic diagram illustrating an arrangement of elements in a portion of a sixth embodiment of an optical print head.

### DETAILED DESCRIPTION OF EMBODIMENTS

For clarity of the description, the drawings are not drawn to a uniform scale. In particular, vertical and horizontal scales may differ from each other and may vary from one drawing to another. In this regard, directional terminology, such as “top,” “bottom,” “front,” “back,” “leading,” “trailing,” etc., is used with reference to the orientation of the drawing figure(s) being described. Because components of the invention can be positioned in a number of different orientations, the directional terminology is used for purposes of illustration and is in no way limiting. Similarly, for purposes of illustration but in no way limiting, optical diagrams may be drawn to non-uniform scales and may show elements with non-proportional dimensions.

The terms “recordable medium” and “recordable media” as used in this specification and the appended claims refer to media capable of having information recorded thereon by exposure to optical radiation such as laser light. Such recordable media may include, for example, a compact disk (CD), a digital versatile disk (DVD), an HD-DVD, a Blu-ray Disc™ (BD), a holographic versatile disk (HVD), or a video disk, but are not limited to such forms. Recordable media may also include such media having pre-recorded information readable from at least one side and having an optically-recordable coating on at least the other side for writing a label on the media. The term “recording” means recording or printing a label or other information on a recordable medium such as an optical storage disk.

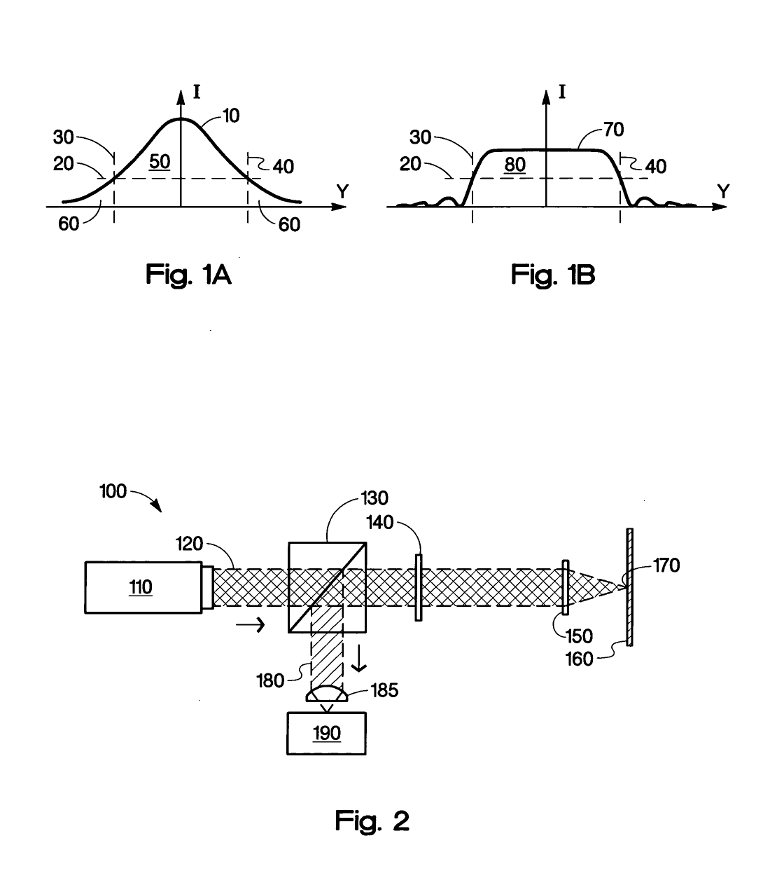

FIG. 1A shows a graph of a Gaussian irradiance distribution profile 10 of laser light, in which the distribution of irradiance (I) across the laser beam has a conventional Gaussian form. Horizontal axis (y) represents a linear spatial dimension perpendicular to the laser beam. Horizontal line 20 indicates a threshold for writing in a typical recording medium. Vertical lines 30 and 40 indicate the intersections of writing threshold line 20 with the Gaussian irradiance profile 10. Only the region 50 between vertical lines 30 and 40 (above writing threshold line 20) represents laser radiation effective in writing in the recording medium. Portions outside the region 50 of the laser light, denoted by reference numeral 60 in FIG. 1A, are not effective for writing in the recording medium and are therefore wasted. Thus, imaging of a thermochromic imageable coating is more energy-efficient if imaging laser beam has relatively uniform (non-Gaussian) energy density profile enabling uniform color development across the whole area of the spot. FIG. 1B shows a graph depicting a non-Gaussian irradiance distribution profile 70 of laser light formed by embodiments of an optical print head as described hereinbelow. Horizontal line 20 again indicates the threshold for writing in a typical recording medium. Vertical lines 30 and 40 indicate the intersections of writing threshold line 20 with the non-Gaussian irradiance profile 70. Because of the flatter top and steeper sides of profile 70 in comparison with Gaussian profile 10, the portion 80 between vertical lines 30 and 40 (above writing threshold line 20), representing laser radiation effective in writing in the recording medium, includes more laser-light energy effective for writing. Thus, less laser-light energy is wasted when recording with the non-Gaussian irradiance distribution profile 70 of FIG. 1B than when recording with the Gaussian irradiance distribution profile 10 of FIG. 1A.

To achieve the non-Gaussian irradiance distribution profile, an optical print head for recording on a medium includes a laser light source which may include a number of lasers having laser emissions within a desired wavelength range. The optical print head has a beam splitter and/or a multi-mode optical fiber adapted to receive combined output light from the lasers of the laser light source and to direct their combined output light in a first beam direction. A sensor may be disposed along a second beam direction to detect light reflected back from the recording medium. A holographic optical element focuses the combined output light within the desired wavelength range into a spot with non-Gaussian irradiance on the recording medium.

Thus, one aspect of embodiments disclosed herein provides an optical print head 100 as shown in FIG. 2, which provides a non-Gaussian irradiance distribution profile 70 like that of FIG. 1B. FIG. 2 shows a laser light source 110, which may include a number of lasers having laser emissions within a desired wavelength range, emitting combined laser output light beam 120. The desired range wavelength range may include wavelengths between about 365 nanometers and about 1600 nanometers, for example.

If a number of different wavelengths are not required, the lasers making up laser light source 110 may all have laser emissions of substantially equal wavelengths so that their combined output light 120 is substantially monochromatic, for example with a wavelength of 780 nanometers. Such a laser light source 110 can provide a higher power monochromatic combined output light 120 without the disproportionately higher cost of a single high-power laser.

A beam splitter 130 receives combined output light 120 from the various lasers, to direct their combined output light 120 into a first beam direction and to direct modulated light 180 from recording medium 160 into a second beam direction. A sensor 190 able to detect the modulated light is disposed along the second beam direction. A quarter-wave plate 140 may be disposed along an optical path between the beam splitter and the medium 160.

A holographic optical element 150 is disposed between the beam splitter and recording medium 160. The holographic optical element focuses the combined output light within the desired wavelength range into a spot 170 with non-Gaussian irradiance on recording medium 160.

As shown in FIG. 1B, the non-Gaussian irradiance has a substantially uniform (flat-topped) irradiance profile 70. As compared with a perfectly uniform irradiance profile the non-Gaussian irradiance may have a mean square error minimized over a substantially circular area having a diameter of about 25 micrometers or less, for example. A typical spot 170 thus optimized may have a diameter matching a track width of about 23 micrometers, for example, on recording medium 160.

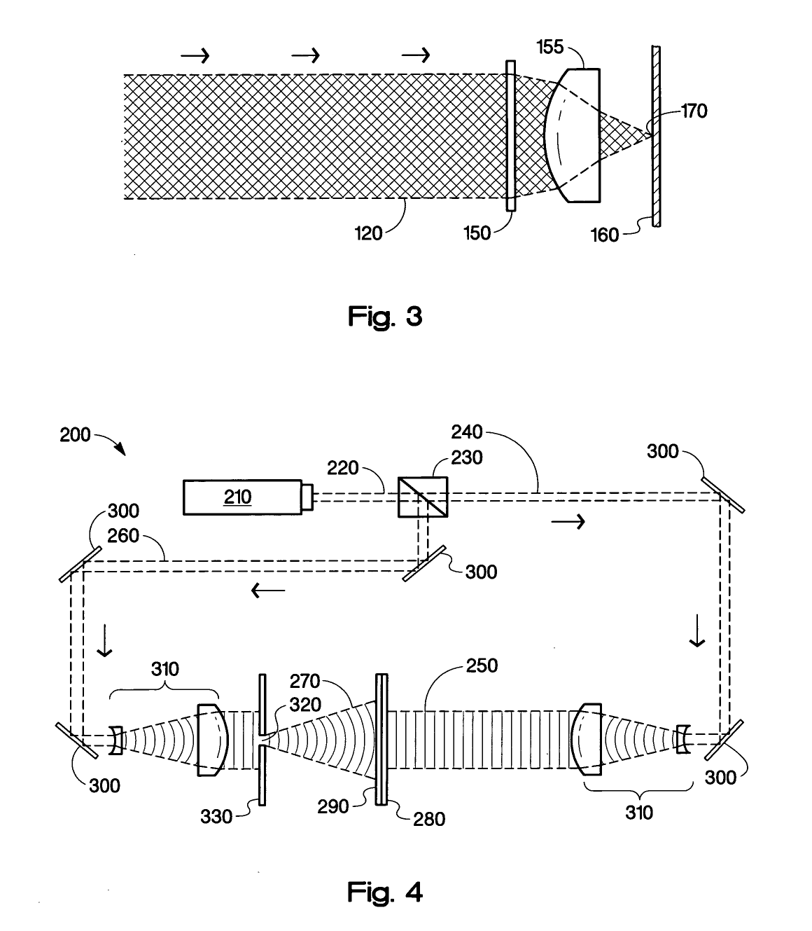

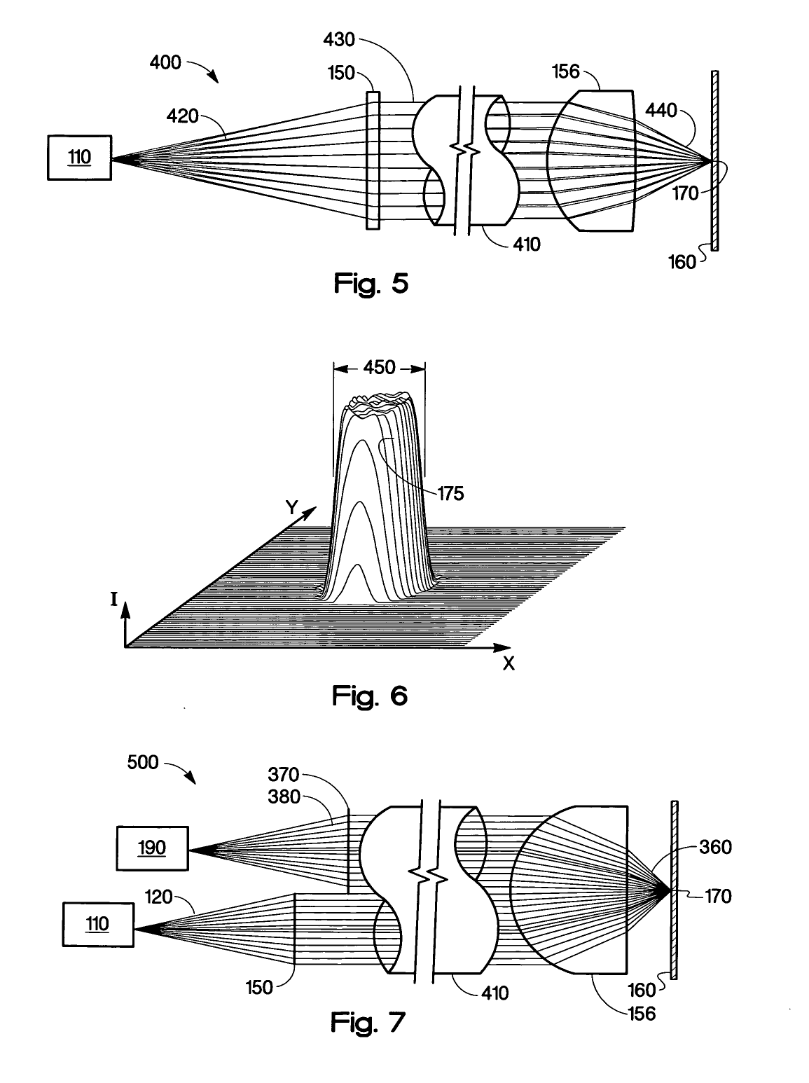

Since laser light source 110 may include a number of lasers that have laser emissions of various different wavelengths within the desired wavelength range, the holographic optical element 150 may be advantageously made to be substantially achromatic. Laser light of different wavelengths is focused at the same focal distance. Holographic optical element 150 may also be made to be substantially free from spherical aberration as well as being achromatic. Holographic optical element 150 may include a holographic lens having a numerical aperture (NA) of about 0.05. For example, holographic optical element 150 may be combined with a refractive lens 155, as shown in FIG. 3. The combination may have a numerical aperture (NA) of about 0.05. The holographic optical element 150 may be made by molding and/or stamping a plastic material that is substantially transparent for all wavelengths in the desired wavelength range. Some plastic materials whose refractive index and other properties are suitable for some applications are polycarbonate and polymethylmethacrylate (PMMA). While shown as separate discrete elements 150 and 155 in FIG. 3 to illustrate the principle of such embodiments, the diffractive and refractive functions may instead be combined and integrated conveniently in a hybrid holographic optical element 156 (shown in FIGS. 5 and 7, for example).

FIG. 4 is a schematic optical diagram showing an embodiment 200 of apparatus for making embodiments of holographic optical elements 150 for optical print heads. A laser light source 210 emits a beam of coherent laser radiation 220. Beam 220 is split by a beam splitter 230 into two beams: a first beam 240 for forming a reference beam 250, and a separate beam 260 for forming an object beam 270. A number of mirrors 300 may be used to re-direct the beams as needed. Beam expanding telescopes 310 expand reference beam 250 and object beam 270 respectively to ensure that these beams are larger than a suitable exposure area for exposing a holographic master. A transparent plate 280 is coated with a layer of photoresist 290. Object beam 270 is formed by light passing through an aperture 320 in an opaque plate 330. In this recording process, object beam 270 from aperture 320 has a substantially flat irradiance distribution. Interference between reference beam 250 and object beam 270 makes a holographic pattern in photoresist 290. The holographic pattern in photoresist 290 is then developed and plated in a conventional manner and forms a master stamper used to replicate holographic optical elements 150 in mass production. During “playback” by the optical print head, the writing laser beam will replicate the wavefront of object beam 270 of FIG. 4, and thus will generate the same type of flat-topped non-Gaussian irradiance distribution in spot 170 on recording medium 160.

Another aspect of embodiments disclosed herein is the embodiment of an optical print head 400 as shown schematically in FIG. 5. Again, laser light source 110 may include a number of lasers having laser emissions within a desired wavelength range. A multi-mode optical fiber 410 receives light 420 from each of the lasers at a one end of the fiber and emits combined output light 440 at the other (output) end of the fiber. A holographic or hybrid optical element 150 may be used for collimation of the light 420 so that a collimated beam 430 enters multi-mode optical fiber 410. A hybrid optical element 156 is optically coupled to the output end of the multi-mode optical fiber and focuses the combined output light 440 within the desired wavelength range into a spot 170 with non-Gaussian irradiance on the recording medium 160 as described above for the first embodiment. As shown in FIG. 5, hybrid optical element 156 may have one generally flat side incorporating diffractive features of a holographic optical element and another curved side shaped to provide the refractive function of the hybrid optical element, taking into account the refractive index of the material of the hybrid optical element. Hybrid holographic optical element 156 may be made substantially achromatic as well as being substantially free from spherical aberration. In the embodiment of FIG. 5, no beam splitter or quarter-wave plate is needed.

FIG. 6 shows a perspective view of a three-dimensional graph depicting an exemplary embodiment of an irradiance distribution 175 of laser light in spot 170. Spot 170 may be optimized to have a diameter 450 matching a track width on recording medium 160, about 25 micrometers or less, for example.

Another aspect of embodiments disclosed herein is the embodiment of an optical print head 500 shown schematically in FIG. 7. Again, laser light source 110 may include a number of lasers having laser emissions within a desired wavelength range. Through a holographic optical element 150, a multi-mode optical fiber 410 receives combined light 120 at one end of the fiber. A sensor 190 may be disposed to receive and detect light 380 reflected from the recording medium 160, transmitted through the multi-mode optical fiber 410 from the second (“output”) end to the first (“input”) end of the fiber, and emitted from the first end of the fiber. A lens 370 having a suitable numerical aperture (NA) may be used to focus light 380 on sensor 190. Again, in the embodiment of FIG. 7, no beam splitter or quarter-wave plate is needed.

Although FIGS. 5 and 7 show the laser, optical fiber, and lens as being aligned coaxially, in practice the laser and/or lenses may be oriented at a small angle to the optical fiber axis in order to prevent an unwanted amount of reflected light from returning to the laser after reflection from the medium, which could otherwise cause undesired side effects, such as oscillation in the source laser. In other embodiments the combination of a beam splitter and quarter-wave plate may be used to guide the reflected beam to the sensor and prevent the reflected beam from returning to the source laser.

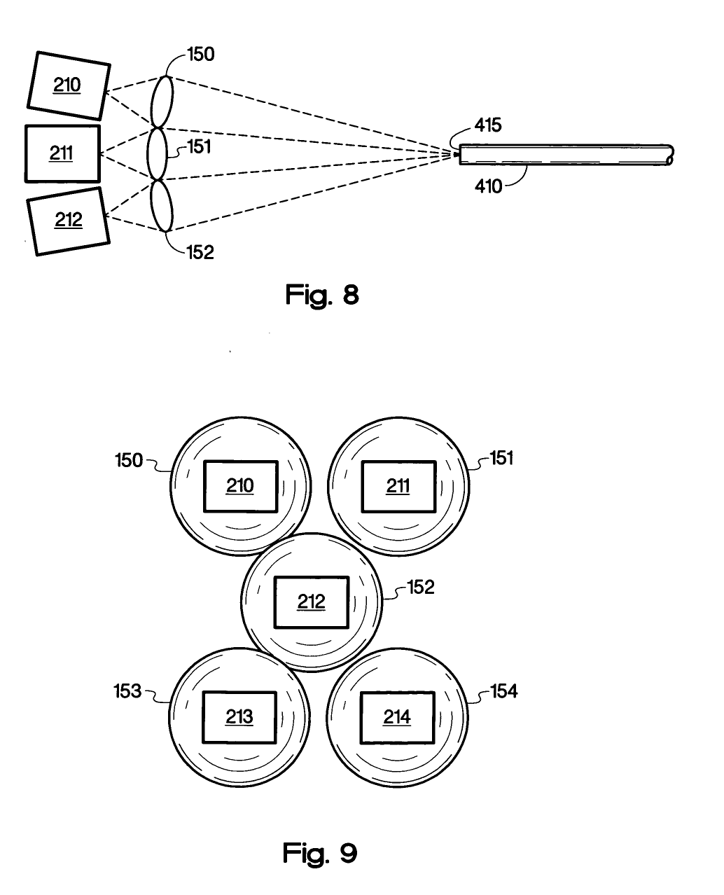

Another aspect of embodiments disclosed herein is the embodiment portion shown schematically in FIG. 8. As described above in connection with other embodiments, the laser light source may include a number of lasers 210, 211, and 212 having laser emissions within a desired wavelength range. The desired wavelength range may include wavelengths between about 365 nanometers and about 1600 nanometers, for example. In a specific example embodiment, laser 210 may have a wavelength of 600 nanometers, laser 211 may have a wavelength of 900 nanometers, and laser 212 may have a wavelength of 1300 nanometers. Or, alternatively, all three lasers may have substantially equal wavelengths, e.g., 780 nanometers. A multi-mode optical fiber 410 receives light from each of the lasers at one end 415 of the fiber. Multi-mode optical fiber 410 may have a diameter of 30 micrometers to 50 micrometers, for example, and may have a numerical aperture (NA) of 0.22, for example. Lenses 150, 151, and 152 focus laser light from lasers 210, 211, and 212 respectively onto end 415 of multi-mode optical fiber 410. As described above, lenses 150, 151, and 152 may be holographic optical elements or hybrid holographic optical elements.

FIG. 9 is a schematic diagram illustrating an arrangement of elements in a portion of another embodiment of an optical print head. At the laser-light-source end of multi-mode optical fiber 410, a number of laser diodes may be arranged within the effective angular range of the numerical aperture of multi-mode optical fiber 410. Each laser diode 210, 211, 212, 213, and 214, for example, is aligned with a single suitable holographic optical element or hybrid holographic optical element 150, 151, 152, 153, or 154 respectively. Alternatively, holographic optical elements 150, 151, 152, 153, or 154 may be integrated into a single composite optical element (not shown) having a number of holographic optical elements. In the latter case the single composite holographic optical element is optically aligned with multi-mode optical fiber 410, and each laser diode 210, 211, 212, 213, and 214 is aligned with its own portion of the composite holographic optical element. Of course, other embodiments may have more or fewer lasers than the three- or five-laser examples shown in FIGS. 8 and 9.

For particular applications, embodiments such as those of FIGS. 2 and 3 may also incorporate features of embodiments such as those of FIGS. 5-9. Thus, an optical print head may be made by combining a number of lasers having laser emissions within a desired wavelength range, a multi-mode optical fiber receiving light from each of the plurality of lasers at one end and emitting combined output light at its other end, a beam splitter receiving combined output light from the multi-mode optical fiber and directing the combined output light in a first beam direction while also directing modulated light reflected light from recorded media through the multi-mode optical fiber, a sensor to detect light reflected from the medium and transmitted through the multi-mode optical fiber, and a holographic optical element suitably disposed to focus the combined output light within the desired wavelength range into a spot with non-Gaussian irradiance on the medium for recording. If required, such an embodiment may include a quarter-wave plate disposed along an optical path between the beam splitter and the medium.

A particular embodiment of an optical print head includes a plurality of lasers having laser emissions within a desired wavelength range; a multi-mode optical fiber adapted to receive light from each of the plurality of lasers at one (input) end of the fiber and to emit combined output light at the other (output) end; a sensor adapted to detect light reflected from the medium; a beam splitter adapted to receive combined output light from the output end of the multi-mode optical fiber, to direct the combined output light in a first beam direction and to direct modulated light from recorded media toward the sensor; and a holographic optical element disposed between the second end of the multi-mode optical fiber and a recording medium position. As in other embodiments, the holographic optical element is adapted to focus the combined output light within the desired wavelength range into a spot with non-Gaussian irradiance on the medium for recording.

In any such embodiments, the non-Gaussian irradiance may have a substantially uniform irradiance profile. As compared with a perfectly uniform irradiance profile, the non-Gaussian irradiance has a mean square error minimized over a substantially circular area having a predetermined diameter, e.g., about 20 micrometers. The lasers combining to form the laser light source may have laser emissions of various different wavelengths within the desired wavelength range, for example including wavelengths between about 365 nanometers and about 1600 nanometers. Or, alternatively, the lasers combining to form the laser light source may have laser emissions of substantially equal wavelength, e.g., about 780 nanometers. Typically, the holographic optical element of such embodiments is formed as a holographic or hybrid holographic lens having a numerical aperture (NA) of about 0.05 to operate efficiently with a multi-mode optical fiber of suitable diameter.

### INDUSTRIAL APPLICABILITY

Devices made in accordance with the disclosed embodiments and their equivalents are useful in optical recording. Optical print head embodiments having laser light sources incorporating multiple lasers including various wavelengths are useful in color optical recording. Optical print head embodiments having laser light sources incorporating multiple lasers of the same wavelength are useful in optical recording at relatively high power. Optical print head embodiments employing an optical fiber may be used when separation of lasers from other components is required to avoid thermal interactions.

Although the foregoing has been a description and illustration of specific embodiments of the invention, various modifications and changes thereto can be made by persons skilled in the art without departing from the scope and spirit of the invention as defined by the following claims. For instance, various optical elements (reflective, refractive, diffractive, holographic, or hybrid elements, for example) may be included to perform various desired optical functions in an optical print head. Functionally equivalent materials may be substituted for specific materials described.

What is claimed is:

1. An optical print head for recording on a medium, comprising:
a) a plurality of lasers having laser emissions within a desired wavelength range;
b) a beam splitter adapted to receive combined output light from the plurality of lasers, to direct their combined output light into a first beam direction, and to direct modulated light from the medium into a second beam direction; and
c) a holographic optical element adapted to focus the combined output light into a spot with non-Gaussian irradiance on the medium.

2. The optical print head of claim 1, further comprising a sensor disposed along the second beam direction and adapted to detect the modulated light.

3. The optical print head of claim 1, wherein the medium is an optical storage disk.

4. The optical print head of claim 1, further comprising a quarter-wave plate disposed along an optical path between the beam splitter and the medium.

5. The optical print head of claim 1, wherein the non-Gaussian irradiance has a substantially uniform irradiance profile.

6. The optical print head of claim 5, wherein the non-Gaussian irradiance as compared with a perfectly uniform irradiance profile has a mean square error minimized over a substantially circular area having a diameter of about 25 micrometers or less.

7. The optical print head of claim 1, wherein the plurality of lasers have laser emissions of different wavelengths within the desired wavelength range.

8. The optical print head of claim 1, wherein the plurality of lasers have laser emissions of different wavelengths within a wavelength range including wavelengths between about 365 nanometers and about 1600 nanometers.

9. The optical print head of claim 1, wherein the holographic optical element is substantially achromatic.

10. The optical print head of claim 1, wherein the holographic optical element comprises a holographic lens having a numerical aperture (NA) of about 0.05.

11. The optical print head of claim 1, wherein the holographic optical element comprises a combination of a holographic lens and a refractive lens, the combination having a numerical aperture (NA) of about 0.05.

12. The optical print head of claim 1, wherein the holographic optical element is a plastic material that is substantially transparent in the desired wavelength range.

13. The optical print head of claim 1, wherein the plurality of lasers have laser emissions of substantially equal wavelengths.

14. The optical print head of claim 13, wherein all the substantially equal wavelengths of the plurality of lasers are about 780 nanometers.

15. An optical print head for recording on a medium, comprising:
a) a plurality of lasers having laser emissions within a desired wavelength range,
b) a multi-mode optical fiber adapted to receive light from each of the plurality of lasers at a first end thereof and to emit combined output light at a second end thereof, and
c) a hybrid holographic optical element optically coupled to the second end of the multi-mode optical fiber and adapted to focus the combined output light within the desired wavelength range into a spot with non-Gaussian irradiance on the medium.

16. The optical print head of claim 15, further comprising:
d) a sensor disposed and adapted to detect light reflected from the medium, transmitted through the multi-mode optical fiber from the second end to the first end thereof, and emitted from the first end thereof.

17. An optical print head for recording on a medium, comprising:
a) a plurality of lasers having laser emissions within a desired wavelength range;
b) a multi-mode optical fiber adapted to receive light from each of the plurality of lasers at a first end thereof and to emit combined output light at a second end thereof;
c) a sensor adapted to detect light reflected from the medium;
d) a beam splitter adapted to receive combined output light from the second end of the multi-mode optical fiber, to direct the combined output light in a first beam direction and to direct modulated light from recorded media toward the sensor; and
e) a holographic optical element disposed between the second end of the multi-mode optical fiber and the medium, the holographic optical element being adapted to focus the combined output light within the desired wavelength range into a spot with non-Gaussian irradiance on the medium.

18. The optical print head of claim 17, further comprising a quarter-wave plate disposed along an optical path between the beam splitter and the medium.

19. The optical print head of claim 17, wherein the non-Gaussian irradiance has a substantially uniform irradiance profile, and wherein the non-Gaussian irradiance as compared with a perfectly uniform irradiance profile has a mean square error minimized over a substantially circular area having a diameter of about 20 micrometers.

20. The optical print head of claim 17, wherein the plurality of lasers have laser emissions of differing wavelengths within the desired wavelength range including wavelengths between about 365 nanometers and about 1600 nanometers.

21. The optical print head of claim 17, wherein the plurality of lasers have laser emissions of substantially equal wavelength of about 780 nanometers.

22. An optical print head for recording a label on a medium, comprising:
a) a plurality of means for emitting coherent light having emissions within a desired wavelength range,
b) optical fiber means for receiving combined light from the plurality of means for emitting at a first end thereof and for emitting combined output light at a second end thereof, and
c) holographic optical means disposed and adapted for focusing the combined output light into a spot with non-Gaussian irradiance on the medium.

23. The optical print head of claim 22, wherein the medium is an optical storage disk.
